(19) United States
(12) Patent Application Publication
(10) Pub. No.: US 2021/0302153 A1
(43) Pub. Date: Sep. 30, 2021

(54) Variable Interference-Fringe-Interval Optical Circuit and Fringe Projection Device

(71) Applicant: Nippon Telegraph and Telephone Corporation, Tokyo (JP)

(72) Inventors: Satomi Katayose, Musashino-shi, Tokyo (JP); Ryoichi Kasahara, Musashino-shi, Tokyo (JP); Yuji Fujiwara, Musashino-shi, Tokyo (JP)

(21) Appl. No.: 17/265,094

(22) PCT Filed: Aug. 1, 2019
(86) PCT No.: PCT/JP2019/030325

§ 371 Date: Feb. 1, 2021

(30) Foreign Application Priority Data
Aug. 9, 2018 (JP) 2018-150406

(51) Int. Cl. G01B 11/25; G01B 11/24

(52) U.S. Cl. CPC G01B 11/2518; G01B 11/2441

(57) ABSTRACT

Provided is a fringe projection device capable of adjusting resolution and measurement accuracy without increasing the number of light sources, performing position adjustment of the emission point and the surface to be inspected, or increasing device costs and measurement procedures. A waveguide-type optical phase modulator of the present invention includes a waveguide-type optical element in which an optical waveguide is formed on a substrate, the waveguide-type optical element including: at least one input waveguide to which an optical signal is input; a one-input and N-output (N is an integer of 2 or more) branch waveguide that is optically connected to an output of the input waveguide; 1×M (M is an integer of 2 or more) optical switches that are optically connected to outputs of the branch waveguide; (N×M) phase shifters that are optically connected to outputs of the optical switches; and (N×M) output waveguides that are optically connected to outputs of the phase shifters.

### TECHNICAL FIELD

The present invention relates to an optical circuit, in which an interval between interference fringes is variable, and a fringe projection device.

### BACKGROUND ART

A fringe scanning method is a method of measuring a three-dimensional shape of an object surface in a non-contact manner. Such a method is a method of projecting an interference fringe generated from a coherent light source and having brightness, which changes sinusoidally, onto a measurement object, shifting a phase of the interference fringe at regular intervals to analyze images captured several times, and measuring the shape. In such a method, a depth and a height of an unevenness at each point can be obtained from the amount of scanning of the interference fringes and the change in the light intensity at each point of the projected image. The amount of scanning of the interference fringes is controlled by changing a phase difference between two or more light beams to be interfered. For example, the amount of scanning of the interference fringes to be projected is controlled by changing one phase of bifurcated optical waveguides using, for example, an electro-optic effect (for example, see Patent Literature 1). A waveguide-type optical phase modulator configured to scan the interference fringes includes, on the same substrate, an input waveguide to which light is input, a branch waveguide through which the light is divided, a phase shifter that changes a phase of the light, and an output waveguide from which the light is emitted.

### CITATION LIST

### Patent Literature

Patent Literature 1: Japanese Patent Laid-Open No. 5-87543

### SUMMARY OF THE INVENTION

### Technical Problem

A case is considered in which a three-dimensional shape is measured using a fringe scanning method in a measurement system in which a wavelength of a light source is constant and a positional relation between a surface to be inspected, and a light source and a camera (imaging surface) is fixed.

A dynamic range of measurement in the fringe scanning method is basically limited to a phase range of 2π. When the dynamic range of the measurement object is large and exceeds 2π as a conversion phase value, it will be folded between main values of (−π, π), and a phase distribution will have an uncertain value that is an integer multiple of 2π. Therefore, a phase unwrapping method is required to remove a discontinuous step caused by the folding and to restore the original phase distribution, but in this case, it is considered to change a fringe interval of the interference fringes.

Further, even when it is necessary to further adjust measurement accuracy or resolution from the result of measurement under certain measurement conditions, it is considered to change a fringe interval of the interference fringes. Focusing on the measurement accuracy, when the number of interference fringes is small and the fringes are arranged at wide intervals, the measurement accuracy is higher than when a large number of interference fringes are arranged at narrow intervals. On the other hand, since it is necessary to narrow the fringe interval of the interference fringes to increase the resolution, the resolution will be sacrificed when the fringe interval is widened to increase the measurement accuracy. Therefore, it is necessary to adjust the measurement accuracy and the resolution according to the measurement object.

The fringe interval of the interference fringes is changed by a method of adjusting a measurement wavelength, a positional relation between a surface to be inspected and an emission point, and an emission interval of light beams to be interfered. For example, in order to narrow the fringe interval of the interference fringes, it is necessary to shorten the wavelength of the light source, increase the distance between the surface to be inspected and the emission point, or lengthen the emission interval of the light beams to be interfered. In any case, redesigning or remanufacturing may be required when the waveguide-type optical phase modulator is used during an increase in the number of light sources or position adjustment of the optical system (including the light source, the screen, and the camera), and costs of equipment and operation may be expensively required. Further, it is difficult to construct a positional relation for obtaining a desired fringe interval under a condition that a movable range of the surface to be inspected, the light source, and the camera is restricted.

The present invention has been made to solve the above problems, and an object thereof, which relates to a waveguide-type optical phase modulator in which a fringe interval is variable on one chip, is to provide a fringe projection device capable of controlling a measurement range, a resolution, and measurement accuracy for three-dimensional shape measurement.

### Means for Solving the Problem

In order to achieve such an object, an aspect of the present invention relates to a fringe projection device including a waveguide-type optical phase modulator. The fringe projection device includes a phase modulator including a light source, a screen (a surface to be inspected), a camera (an imaging surface), an input waveguide portion to which light is input from the light source, a branch waveguide connected to the input waveguide, an optical switch connected to the branch waveguide, a phase shifter connected to the optical switch, and an output waveguide connected to the phase shifter.

According to a first aspect of the present invention, a waveguide-type optical phase modulator includes a waveguide-type optical element in which an optical waveguide is formed on a substrate, the waveguide-type optical element including: at least one input waveguide to which an optical signal is input; a one-input and N-output (N is an integer of 2 or more) branch waveguide that is optically connected to an output of the input waveguide; 1×M (M is an integer of 2 or more) optical switches that are optically connected to outputs of the branch waveguide; (N×M) phase shifters that are optically connected to outputs of the optical switches; and (N×M) output waveguides that are optically connected to outputs of the phase shifters.

According to a second aspect of the present invention, in the waveguide-type optical phase modulator according to the first aspect, an interval between ends of the output waveguides extending from the same 1×M optical switch of the 1×M optical switches is different in length from an interval between ends of the output waveguides adjacent to each other extending from different 1×M optical switches.

According to a third aspect of the present invention, in the waveguide-type optical phase modulator according to the first or the second aspect, a 1×M optical switch having a multi-stage structure is optically connected to at least one of the outputs of the branch waveguide.

According to a fourth aspect of the present invention, in the waveguide-type optical phase modulator according to the first or the second aspect, a 1×M optical switch having a multi-stage structure is optically connected to at least one of the outputs of the branch waveguide, and a 1×M optical switch having a single-stage structure is optically connected to at least one of the outputs of the branch waveguide.

According to a fifth aspect of the present invention, in the waveguide-type optical phase modulator according to any one of the first to fourth aspects, one or more and less than (N×M) heaters are provided on the (N×M) phase shifters.

According to a sixth aspect of the present invention, in the waveguide-type optical phase modulator according to any one of the first to fifth aspects, the branch waveguide is configured of any one of a Y-branch waveguide, a directional coupler, a multimode interference (MMI) coupler, and a star coupler.

According to a seventh aspect of the present invention, in the waveguide-type optical phase modulator according to any one of the first to sixth aspects, a fiber is connected to at least one of both ends of the waveguide-type optical element.

A fringe projection device according to another aspect of the present invention includes: the waveguide-type optical phase modulator according to any one of the first to seventh aspects; a switch and phase shifter control unit that controls a projection pattern of interference fringes generated by interference of light to be output from the output waveguide of the waveguide-type optical phase modulator; and a light source that outputs coherent light to be input to the waveguide-type optical phase modulator.

Note that any combination of the above components and the conversion expression of the present invention into a method, a device, and a system are also effective as an aspect of the present invention.

### Effects of the Invention

According to the present invention, the fringe projection device includes the waveguide-type optical phase modulator having a switch function, so that it is possible to adjust resolution and measurement accuracy without increasing the number of light sources, performing position adjustment of the emission point and the surface to be inspected, or increasing device costs and measurement procedures, which can be expected to reduce costs of equipment and operation.

### BRIEF DESCRIPTION OF DRAWINGS

FIG. 1 is a top view schematically showing a configuration of a phase modulator according to Example 1.

FIG. 2 is a top view schematically showing an operation of the phase modulator according to Example 1.

FIG. 3 is a top view schematically showing a configuration of a phase modulator according to Modification 1.

FIG. 4 is a top view schematically showing a configuration of a phase modulator according to Modification 2.

FIG. 5 is a top view schematically showing a configuration of a phase modulator according to Modification 3.

FIG. 6 is a top view schematically showing a configuration of a phase modulator according to Modification 4.

FIG. 7 is a top view schematically showing a configuration of a phase modulator according to Modification 5.

FIG. 8 is a top view schematically showing a configuration of a phase modulator according to Modification 6.

### DESCRIPTION OF EMBODIMENT

Modes of an interference fringe interval-variable optical circuit and a fringe projection device of the present invention will be described below with reference to the drawings. However, the present invention is not limited to the description of an embodiment and examples below, and it will be obvious to those skilled in the art that modes and details can be changed variously without departing from the spirit of the invention disclosed in the description.

First, the outline of the embodiment according to the present invention will be described. One aspect of the present invention relates to a fringe projection device including a light source, a screen (a surface to be inspected), a camera (an imaging surface), and waveguide-type optical phase modulator. In any fringe projection device, when a positional relation between the surface to be inspected, the light source, and the camera is fixed, a fringe interval of interference fringes becomes wider as an emission interval of light beams to be interfered becomes shorter, and becomes narrower as the emission interval becomes longer. The present invention is to control a fringe interval by controlling an emission interval of light beams to be interfered on a one-chip waveguide-type optical phase modulator without moving a positional relation of optical systems (a light source, a screen, and a camera).

A fringe projection device includes a waveguide-type optical phase modulator including an input waveguide portion to which light is input from a light source, a branch waveguide connected to the input waveguide, an optical switch connected to the branch waveguide, a phase shifter connected to the optical switch, and an output waveguide connected to the phase shifter. Note that any combination of the above components and the conversion expression of the present invention into a method, a device, and a system are also effective as an aspect of the present invention.

The embodiment of the present invention will be described in detail below with reference to the drawings. Configurations described below are merely examples and are not intended to limit the scope of the present invention.

### EXAMPLE 1

A fringe projection device of Example 1 includes a light source 101, a screen 109, a camera 110, and a waveguide-type optical phase modulator 100. Light having coherence is input to the waveguide-type optical phase modulator 100 in order to generate an interference fringe pattern. For example, a single wavelength laser beam is input. The input light is input from the light source 101 to the waveguide-type optical phase modulator 100 via a fiber (optical fiber) 102. The waveguide-type optical phase modulator 100 includes one input waveguide 103 that receives light output from the light source, a branch waveguide 104 that is optically connected to an output of the input waveguide 103, for example, a Y-branch waveguide having a division ratio of 1:1, a switch 105 including 1×2 Mach-Zehnder type optical switches that are optically connected to outputs of the Y-branch waveguide, a phase shifter 106 that is optically connected to outputs of the optical switches to change a phase of light, and an output waveguide 107 that is optically connected to an output of the phase shifter. The switch 105 is electrically connected to a switch control unit of switch and phase shifter control units 108 by wirings. The switch and phase shifter control units 108 control a projection pattern of an interfere fringe generated by interference of the light output from the output waveguide 107.

The optical waveguide is a so-called planar light wave circuit (PLC), and, for example, the optical waveguide is formed in which a clad layer formed of quartz-based glass is provided on a surface of a silicon substrate and a core portion formed of quartz-based glass is provided on an intermediate layer of the clad layer. In addition, the Mach-Zehnder type optical switch and the phase shifter 106 are constituted by a thermo-optic phase shifter using a thermo-optic effect, a thin film heater 106a is formed on the surface of the clad layer.

In the phase shifter 106, the thin film heater 106a provided on the surface of the clad layer heats the waveguide and changes a phase of the waveguide. The heater 106a is electrically connected to a phase shifter control unit of the switch and phase shifter control units 108 by wirings, and operates based on a control signal from the phase shifter control unit. In a fringe scanning method, the phase shifter plays a role of changing the phase of a light beam to be interfered to manipulate the phase of the generated interference fringe.

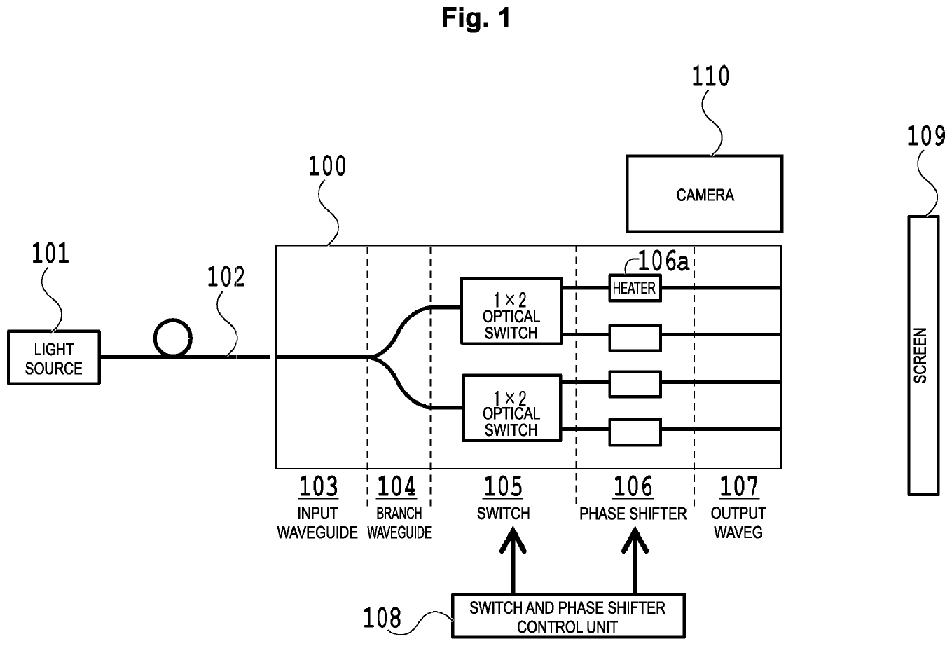

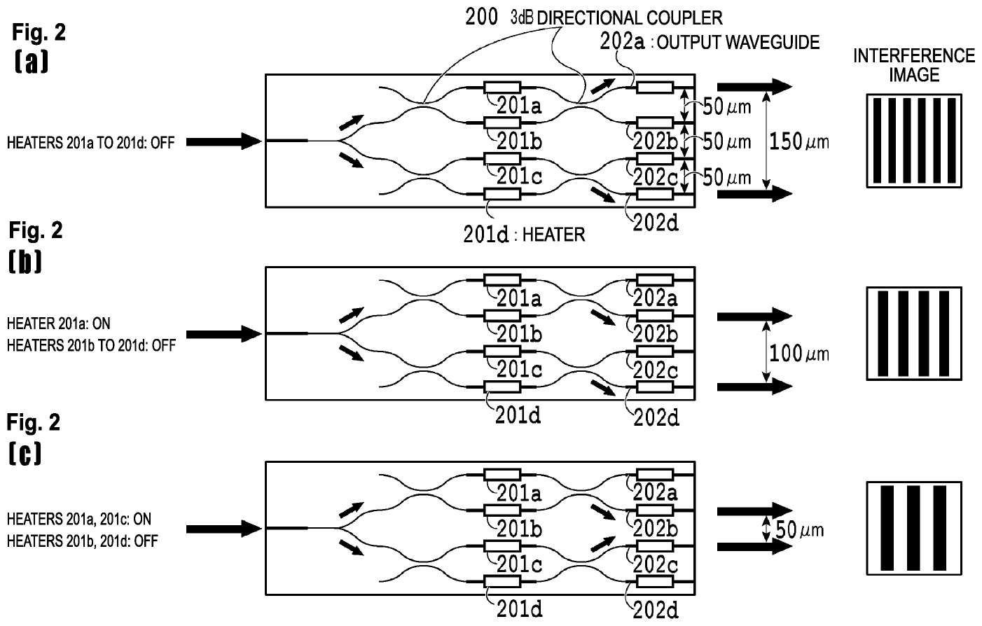

As shown in FIG. 2, the Mach-Zehnder type optical switch includes two 3 dB directional couplers 200 and a phase shifter using thin film heaters 201a to 201d provided between these directional couplers. Such an optical switch corresponds to the 1×2 optical switch in FIG. 1. In FIG. 2, a portion corresponding to the phase shifter in FIG. 1 is not shown. An optical path length difference |ΔLopt| between two waveguides connecting two directional couplers 200 is designed to be 0 (|ΔLopt|=0) or a half of a signal light wavelength λ (|ΔLopt|=λ/2) depending on the purpose of use.

Here, a description will be given with respect to an operation of controlling an emission interval of the light beam to be interfered by the Mach-Zehnder type optical switch (thereby, changing the fringe interval of the interference fringes) when an interval between output waveguides is 50 μm.

A case of a Mach-Zehnder type optical switch with an optical path length difference of 0 will be described below. When the optical path length difference |ΔLopt| is designed to be 0, a Mach-Zehnder optical interferometer circuit enters a cross state due to a known interference principle when the thin film heaters 201a to 201d are in a power-OFF state (being turned OFF) in both of the two 1×2 Mach-Zehnder type optical switches. For this reason, signal light incident on ends of input waveguides propagates to ends of output waveguides 202a and 202d, and the interval between the waveguides, from which the light is emitted, is 150 μm (FIG. 2(a)).

In addition, the optical path length difference |ΔLopt| between two waveguides connecting the directional couplers is λ/2 when the thin film heater (in this case, the thin film heater 201a) on one side of the two waveguides connecting the directional couplers is in a power-ON state (being turned ON) in one of the two 1×2 Mach-Zehnder type optical switches and the optical path length is phase-changed by a phase corresponding to a half of the signal light wavelength due to the thermo-optic effect. Then, since only the heater-driven circuit of the Mach-Zehnder optical interferometer circuits enters a bar state, the signal light incident on ends of the input waveguides propagates to ends of output waveguides 202b and 202d, and the interval between the waveguides, from which the light is emitted, is 100 μm (FIG. 2(b)).

In addition, the optical path length difference |ΔLopt| between two waveguides connecting the directional couplers is λ/2 when the thin film heater (in this case, the thin film heaters 201a and 201c) on one side of the two waveguides connecting the directional couplers is in a power-ON state (being turned ON) in both of the two 1×2 Mach-Zehnder type optical switches and the optical path length is phase-changed by a phase corresponding to a half of the signal light wavelength due to the thermo-optic effect. Then, since both of the Mach-Zehnder optical interferometer circuits enter a bar state, the signal light incident on ends of the input waveguides propagates to ends of output waveguides 202b and 202c, and the interval between the waveguides, from which the light is emitted, is 50 μm (FIG. 2(c)).

In this way, when the emission interval of the light beams to be interfered on the one-chip waveguide-type optical phase modulator is controlled, it is possible to change the fringe interval of the interference fringes without the need for redesigning or remanufacturing when the waveguide-type optical phase modulator is used during an increase in the number of light sources or position adjustment of the optical system (including the light source, the screen, and the camera).

On the other hand, when the optical path length difference |ΔLopt| is designed to be λ/2, the Mach-Zehnder optical interferometer circuit enters the bar state due to the known interference principle when the thin film heaters are in a power-OFF state (being turned OFF) in both of the two 1×2 Mach-Zehnder type optical switches. For this reason, the signal light incident on the ends of the input waveguides propagates to the ends of the output waveguides 202b and 202c, and the interval between the waveguides, from which the light is emitted, is 50 μm.

In addition, the optical path length difference |ΔLopt| between two waveguides connecting the directional couplers is 0 when the thin film heater (in this case, the thin film heater 202a) on one side of the two waveguides connecting the directional couplers is in a power-ON state (being turned ON) in one of the two 1×2 Mach-Zehnder type optical switches and the optical path length is phase-changed by a phase corresponding to a half of the signal light wavelength due to the thermo-optic effect. Then, since only the heater-driven circuit of the Mach-Zehnder optical interferometer circuits enters a cross state, the signal light incident on the ends of the input waveguides propagates to the ends of output waveguides 202a and 202c (or 202b and 202d), and the interval between the waveguides, from which the light is emitted, is 100 μm.

In addition, the optical path length difference |ΔLopt| between two waveguides connecting the directional couplers is 0 when the thin film heater (in this case, the thin film heaters 202a and 202c) on one side of the two waveguides connecting the directional couplers is in a power-ON state (being turned ON) in both of the two 1×2 Mach-Zehnder type optical switches and the optical path length is phase-changed by a phase corresponding to a half of the signal light wavelength due to the thermo-optic effect. Then, since both of the Mach-Zehnder optical interferometer circuits enter a cross state, the signal light incident on the ends of the input waveguides propagates to the ends of output waveguides 202a and 202d, and the interval between the waveguides, from which the light is emitted, is 150 μm.

The present has been described above based on the Example. Note that the Example is intended to be illustrative only, and it will be obvious to those skilled in the art that various modifications can be made to a combination of the respective components and that such modifications also fall within the scope of the present invention.

For example, the division ratio of the branch waveguide is preferably 1:1 so that a contrast ratio of the interference fringes is increased, but may be arbitrary. The branch waveguide may be not only the Y-branch waveguide, but also a directional coupler, a multimode interference coupler, or a star coupler.

The phase modulator may utilize an electro-optic effect, a carrier plasma dispersion effect, or a photoelastic effect, for example. The waveguide may need not to be linearly configured as a whole, and may be configured to be partially a curved shape.

The phase modulator may be provided with a heat insulating groove for heat insulation and a light-shielding agent filling groove for removing stray light. The phase modulator may be coupled to the optical fiber via a fiber block. The phase modulator may input light from the light source through a lens, or may directly input light from the light source. The phase modulator may directly output light, or may output light via a fiber. The above-described Example and modifications may be applied to not only the fringe scanning method but also a measurement technique using a structured illumination method. The fringe projection device may be equipped with a screen or a camera.

In Example 1, the waveguide-type optical element has been described as an example including one input waveguide to which an optical signal is input, a one-input and two-output branch waveguide that is optically connected to an output of the input waveguide, 1×2 optical switches that are optically connected to outputs of the branch waveguide, four phase shifters that are optically connected to outputs of the 1×2 optical switches, and four output waveguides that are optically connected to outputs of the phase shifters. However, a waveguide-type optical element can also be provided including at least one input waveguide to which an optical signal is input, a one-input and N-output (N is an integer of 2 or more) branch waveguide that is optically connected to an output of the input waveguide, 1×M (M is an integer of 2 or more) optical switches that are optically connected to outputs of the branch waveguide, (N×M) phase shifters that are optically connected to outputs of the optical switches, and (N×M) output waveguides that are optically connected to outputs of the phase shifters.

### MODIFICATION 1

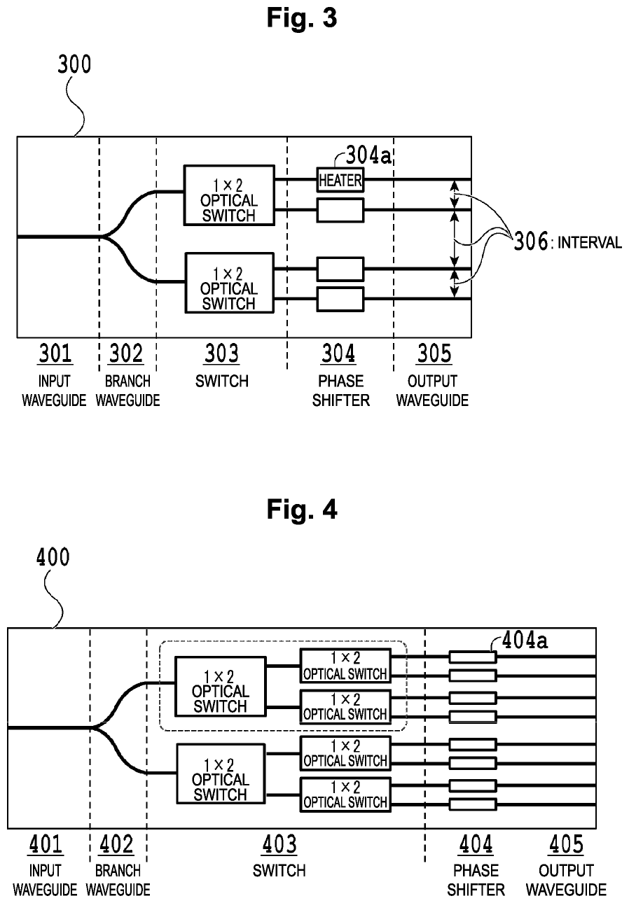

FIG. 3 shows a configuration of a waveguide-type optical phase modulator 300 according to Modification 1. The waveguide-type optical phase modulator 300 includes an input waveguide 301, a branch waveguide 302, a switch 303, a phase shifter 304 provided with a heater 304a, and an output waveguide 305. As shown in FIG. 3, intervals 306 between output waveguides adjacent to each other may be unequal. An interval between ends of the output waveguides extending from the same 1×2 optical switch of the switch 303 may be different in length from an interval between ends of the output waveguides adjacent to each other extending from different 1×2 optical switches. In Modification 1, the 1×2 optical switch is used, but 1×M (M is 3 or more) optical switch may be used.

### MODIFICATION 2

FIG. 4 shows a configuration of a waveguide-type optical phase modulator 400 according to Modification 2. The waveguide-type optical phase modulator 400 includes an input waveguide 401, a branch waveguide 402, a switch 403, a phase shifter 404 provided with a heater 404a, and an output waveguide 405. In the dotted frame of the switch 403, 1×M (in this case, M=4) optical switches may have a multi-stage configuration.

In a waveguide-type optical element including at least one input waveguide to which an optical signal is input, a one-input and N-output (N is an integer of 2 or more) branch waveguide that is optically connected to an output of the input waveguide, 1×M (M is an integer of 2 or more) optical switches that are optically connected to outputs of the branch waveguide, (N×M) phase shifters that are optically connected to outputs of the optical switches, and (N×M) output waveguides that are optically connected to outputs of the phase shifters, the 1×M optical switch having a multi-stage structure may be optically connected to at least one of the outputs of the branch waveguide.

### MODIFICATION 3

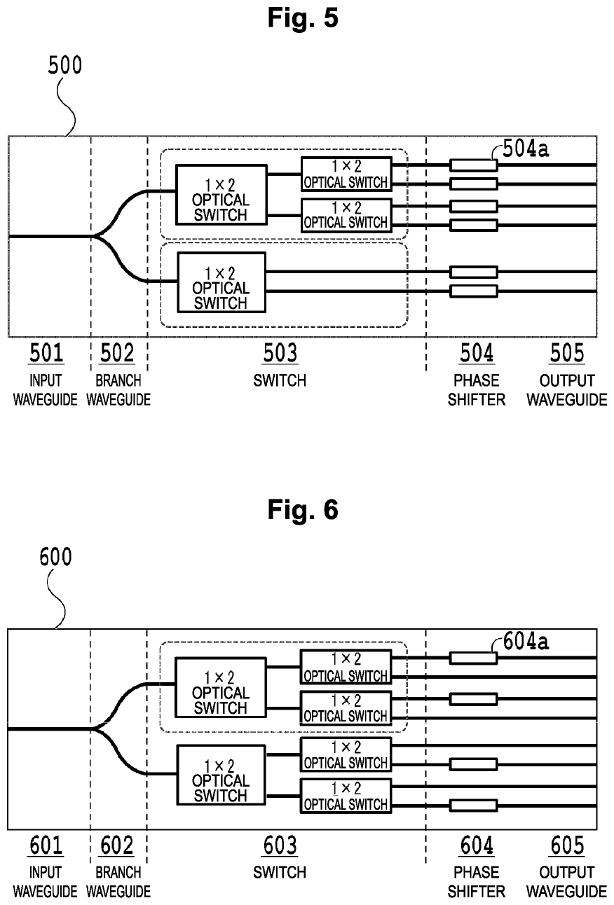

FIG. 5 shows a configuration of a waveguide-type optical phase modulator 500 according to Modification 3. The waveguide-type optical phase modulator 500 includes an input waveguide 501, a branch waveguide 502, a switch 503, a phase shifter 504 provided with a heater 504a, and an output waveguide 505. In the switch 503, the switches connected to the respective branch waveguides may be different, in the number of ports, from each other.

A waveguide-type optical element including at least one input waveguide to which an optical signal is input, a one-input and N-output (N is an integer of 2 or more) branch waveguide that is optically connected to an output of the input waveguide, 1×M (M is an integer of 2 or more) optical switches that are optically connected to outputs of the branch waveguide, (N×M) phase shifters that are optically connected to outputs of the optical switches, and (N×M) output waveguides that are optically connected to outputs of the phase shifters is as follows. In this case, the 1×M optical switch having a multi-stage structure may be optically connected to at least one of the outputs of the branch waveguide, and the 1×M optical switch having a single-stage structure may be optically connected to at least one of the outputs of the branch waveguide.

### MODIFICATION 4

FIG. 6 shows a configuration of a waveguide-type optical phase modulator 600 according to Modification 4. The waveguide-type optical phase modulator 600 includes an input waveguide 601, a branch waveguide 602, a switch 603, a phase shifter 604 provided with a heater 604a, and an output waveguide 605. The phase shifter 604 may have a port in which the heater 604a is not provided. In FIG. 6, a 1×2 optical switch is connected to an end of the output waveguide 505 via a waveguide not provided with the heater, and is connected to an end of the output waveguide 505 via a waveguide provided with the heater 604a.

In a case of a waveguide-type optical element including at least one input waveguide to which an optical signal is input, a one-input and N-output (N is an integer of 2 or more) branch waveguide that is optically connected to an output of the input waveguide, 1×M (M is an integer of 2 or more) optical switches that are optically connected to outputs of the branch waveguide, (N×M) phase shifters that are optically connected to outputs of the optical switches, and (N×M) output waveguides that are optically connected to outputs of the phase shifters, one or more and less than (N×M) heaters may be provided on the (N×M) phase shifters.

### MODIFICATION 5

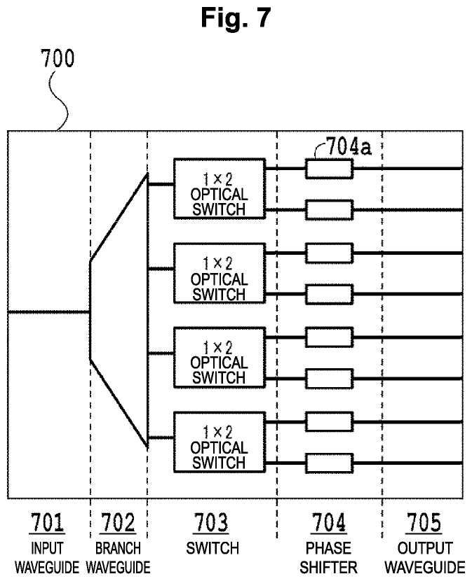

FIG. 7 shows a configuration of a waveguide-type optical phase modulator 700 according to Modification 5. The waveguide-type optical phase modulator 700 includes an input waveguide 701, a branch waveguide 702, a switch 703 including four 1×2 optical switches, a phase shifter 704 provided with a heater 704a, and an output waveguide 705. The branch waveguide 702 may use a star coupler.

### MODIFICATION 6

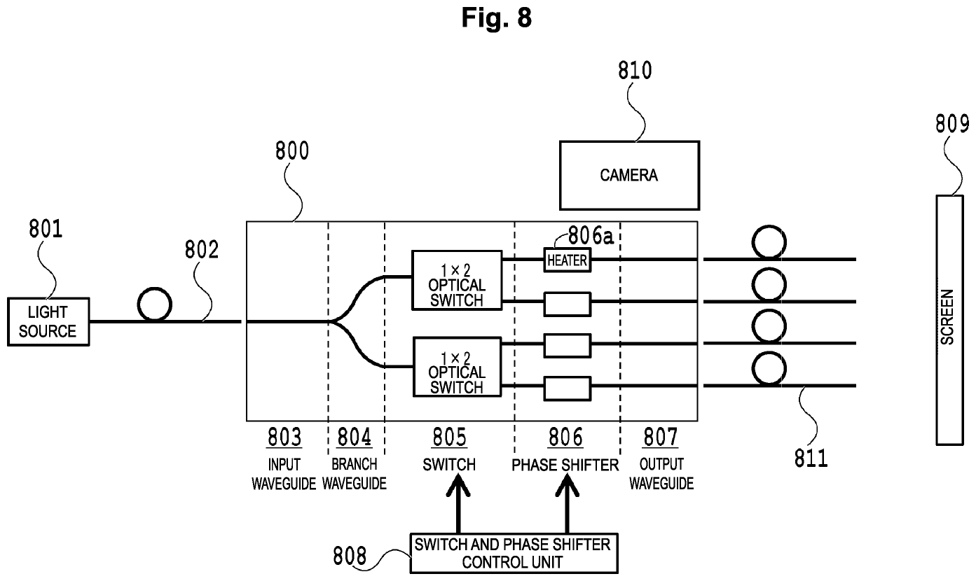

FIG. 8 shows a configuration of a waveguide-type optical phase modulator 800 according to Modification 6. The waveguide-type optical phase modulator 800 includes an input waveguide 803, a branch waveguide 804, a switch 805, a phase shifter 806 provided with a heater 806a, and an output waveguide 807. Fibers 802 and 811 are connected to both ends of the waveguide-type optical phase modulator 800, and the fiber 802 is connected to a light source. A fringe projection device includes the waveguide-type optical phase modulator 800, a light source 801, a switch and phase shifter control unit 808, a screen 809, and a camera 810. The switch and phase shifter control unit 808 controls a projection pattern of an interference fringe generated by interference of light output from the output waveguide 807.

### INDUSTRIAL APPLICABILITY

The present invention is applicable to technical fields of a waveguide-type optical phase modulator, which scans interference fringes, and a fringe projection device using the same.

### REFERENCE SIGNS LIST

100, 300, 400, 500, 600, 700, 800 Waveguide-type optical phase modulator

101, 801 Light source

102, 802, 811 Fiber

103, 301, 401, 501, 601, 701, 803 Input waveguide

104, 302, 402, 502, 602, 702, 803 Branch waveguide

105, 303, 403, 503, 603, 703, 805 Switch

106, 304, 404, 504, 604, 704, 806 Phase shifter

106a, 201a, 201b, 201c, 201d, 304a, 404a, 504a, 604a, 704a, 806a Heater

107, 202a, 202b, 202c, 202d, 305, 405, 505, 605, 705, 807 Output waveguide

108, 808 Switch and phase shifter control unit

109, 809 Screen

110, 810 Camera

200 3 dB directional coupler

306 Interval

1. A waveguide-type optical phase modulator comprising:
a waveguide-type optical element in which an optical waveguide is formed on a substrate, the waveguide-type optical element including:
at least one input waveguide to which an optical signal is input;
a one-input and N-output (N is an integer of 2 or more) branch waveguide that is optically connected to an output of the input waveguide;
1×M (M is an integer of 2 or more) optical switches that are optically connected to outputs of the branch waveguide;
(N×M) phase shifters that are optically connected to outputs of the optical switches; and
(N×M) output waveguides that are optically connected to outputs of the phase shifters.

2. The waveguide-type optical phase modulator according to claim 1, wherein an interval between ends of the output waveguides extending from the same 1×M optical switch of the 1×M optical switches is different in length from an interval between ends of the output waveguides adjacent to each other extending from different 1×M optical switches.

3. The waveguide-type optical phase modulator according to claim 1, wherein a 1×M optical switch having a multi-stage structure is optically connected to at least one of the outputs of the branch waveguide.

4. The waveguide-type optical phase modulator according to claim 1, wherein a 1×M optical switch having a multi-stage structure is optically connected to at least one of the outputs of the branch waveguide, and a 1×M optical switch having a single-stage structure is optically connected to at least one of the outputs of the branch waveguide.

5. The waveguide-type optical phase modulator according to claim 1, wherein one or more and less than (N×M) heaters are provided on the (N×M) phase shifters.

6. The waveguide-type optical phase modulator according to claim 1, wherein the branch waveguide is configured of any one of a Y-branch waveguide, a directional coupler, a multimode interference (MMI) coupler, and a star coupler.

7. The waveguide-type optical phase modulator according to clam 1, wherein a fiber is connected to at least one of both ends of the waveguide-type optical element.

8. A fringe projection device comprising:
the waveguide-type optical phase modulator according to claim 1;
a switch and phase shifter control unit that controls a projection pattern of interference fringes generated by interference of light to be output from an output waveguide of the waveguide-type optical phase modulator; and
a light source that outputs coherent light to be input to the waveguide-type optical phase modulator.
